(19) United States
(12) Patent Application Publication
(10) Pub. No.: US 2006/0085848 A1
(43) Pub. Date: Apr. 20, 2006

(54) Method and apparatus for securing communications between a smartcard and a terminal

(75) Inventors: Selim Aissi, Beaverton, OR (US); Jane Y. Dashevsky, Beaverton, OR (US); Abhay A. Dharmadhikari, Beaverton, OR (US); Benjamin J. Matasar, Portland, OR (US); Jose P. Puthenkulam, Beaverton, OR (US); Mrudula Yelamanchi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/969,739

(22) Filed: Oct. 19, 2004

(51) Int. Cl. H04L 9/32

(52) U.S. Cl. 726/9

(57) ABSTRACT

An approach for securing communication between a terminal and one of a smartcard and a smartcard reader. A command to initiate a local link transport layer protection protocol session between a terminal and one of a smartcard and a smartcard reader is received at the smartcard or smartcard reader. Responsive to the command, the smartcard or smartcard reader then participates in a handshake process between the terminal and one of the smartcard and the smartcard reader. The handshake process includes mutual authentication. Data is then provided from one of the smartcard and the smartcard reader to the terminal via a trusted tunnel after successful completion of the handshake process.

### CROSS-REFERENCE TO RELATED APPLICATIONS

This application is related to co-pending U.S. patent application Ser. No. 10/715,970 entitled, “Method and System To Provide A Trusted Channel Within A Computer System For A SIM Device,” Attorney Docket Number 42P18073, assigned to the assignee of the present invention and filed Nov. 17, 2003 and to co-pending U.S. patent application Ser. No. 10/881,658 entitled, “A System Including a Wireless Wide Area Network (WWAN) Module Associated with an External Identity Module Reader and Approach for Certifying the WWAN Module”, Attorney Docket Number 42P18589, assigned to the assignee of the present invention and filed Jun. 29, 2004.

### BACKGROUND

An embodiment of the present invention relates to the field of electronic systems and, more particularly, to an approach for securing communications between a terminal and one of a smartcard and a smartcard reader.

The insecurity of applications in conventional open personal computing (PC) platforms due to viruses and other attacks is well-known. The Trusted Computing Group (TCG) is developing specifications for enhancing the security of such open PC platforms. The present specifications define several mechanisms for improving the assurance level of the PC platform. Assuming these platforms will support legacy applications, however, it is possible that some peripheral devices and/or other devices that work in connection with the platforms may still be vulnerable to viruses and/or other attacks unless their interfaces are designed to provide adequate security.

### BRIEF DESCRIPTION OF THE DRAWINGS

The present invention is illustrated by way of example and not limitation in the figures of the accompanying drawings in which like references indicate similar elements, and in which:

FIG. 1 is a flow diagram showing a method of one embodiment for establishing secure communications between a terminal and one of a smartcard and a smartcard reader.

FIG. 2 is a block diagram showing an exemplary environment in which the local link transport layer protection protocol of one embodiment may be advantageously implemented.

FIG. 3 is a block diagram illustrating the architecture of a smartcard (e.g. SIM, USIM, UICC, or Java Card) according to one embodiment.

FIG. 4 is a diagram showing the encapsulation of Application APDUs in APDU-TLS for one embodiment.

FIG. 5 is a state diagram showing exemplary states of the local link transport layer protection protocol of one embodiment.

FIG. 6 is a diagram showing the protocol of one embodiment for initiating a local link transport layer protection protocol session.

FIG. 7 is a diagram showing the protocol for a handshake process according to one embodiment.

FIG. 8 is a diagram showing the protocol of one embodiment for exchanging data via a trusted tunnel.

### DETAILED DESCRIPTION

A method and apparatus for securing communications between a smartcard or smartcard reader and a terminal is described. In the following description, particular components, software and hardware modules, systems, protocols, form factors, etc. are described for purposes of illustration. It will be appreciated, however, that other embodiments are applicable to other types of components, software and/or hardware modules, systems protocols, and/or form factors, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Aspects of embodiments of the invention may be described for purposes of illustration as being implemented in one of hardware, firmware or software. It will be appreciated that such aspects may instead be implemented in a different medium.

Presently, there is interest in using a GSM (Global System for Mobile Communications) SIM (Subscriber Identity Module) or USIM (Universal SIM) card to authenticate a wireless local area network (WLAN) subscriber using a laptop PC platform or other mobile computing device. To enable such an implementation, the security issues associated with using hardware credentials such as SIM/USIM cards, smartcards and similar security tokens are important considerations. In particular, some of the existing credential access protocols associated with these devices were designed for closed and/or less hostile environments, and may require enhancements to prevent some of the security threats associated with an open platform such as a PC, for example.

Also, the connection (local link) between platforms needs a sufficient level of protection. Embodiments of the present invention provide an approach for securing the local link between platforms that contain smartcard capabilities (software or hardware). The protection approach described in relation to various embodiments is relatively strong and provides mutual authentication between the two platforms.

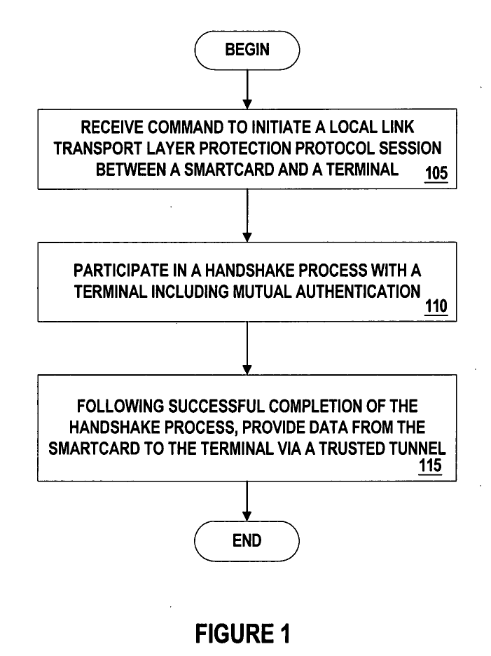

Referring to FIG. 1, to provide for secure communications between a smartcard (ICC or UICC, for example) and/or an associated reader and a platform (also referred to herein as a terminal), an approach of one embodiment includes receiving a command to initiate a local link transport layer protection protocol session between the smartcard and the terminal at block 105. At block 110, responsive to the command, the smartcard participates with the terminal in a handshake process, which includes mutual authentication. Following successful completion of the handshake process, a trusted tunnel is established and data is provided from the smartcard to the terminal via the trusted tunnel at block 115. Communication between the smartcard and the terminal may then proceed according to the local link transport layer protocol.

Smartcard and/or Universal Integrated Circuit Card (UICC), as the terms are used herein, may include, for example, one or more of a Subscriber Identity Module (SIM) card, a Universal SIM (USIM) card, a Removable User Identity Module (RUIM), an IP Multimedia Services Identity Module (ISIM), a Wireless Identity module (WIM), a Java Card, and/or other credential card, functionality or module, and may alternately be referred to herein as a credential, a credential module or card, a token, a machine, or an identity module or card.

The term smartcard reader may be used herein to refer to any device, platform or system that includes a smartcard and is capable of accessing data from the smartcard. Examples may include a cellular/mobile telephone, a personal digital assistant, a notebook-enabled platform, or any other smartcard-holding device.

Terminal, as the term is used herein, refers to an electronic system or platform such as, for example, a laptop, notebook or other type of mobile computing system such as a personal digital assistant, a desktop or enterprise computing system, etc., and may alternately be referred to as a platform or a machine. Other types of electronic systems are within the scope of various embodiments.

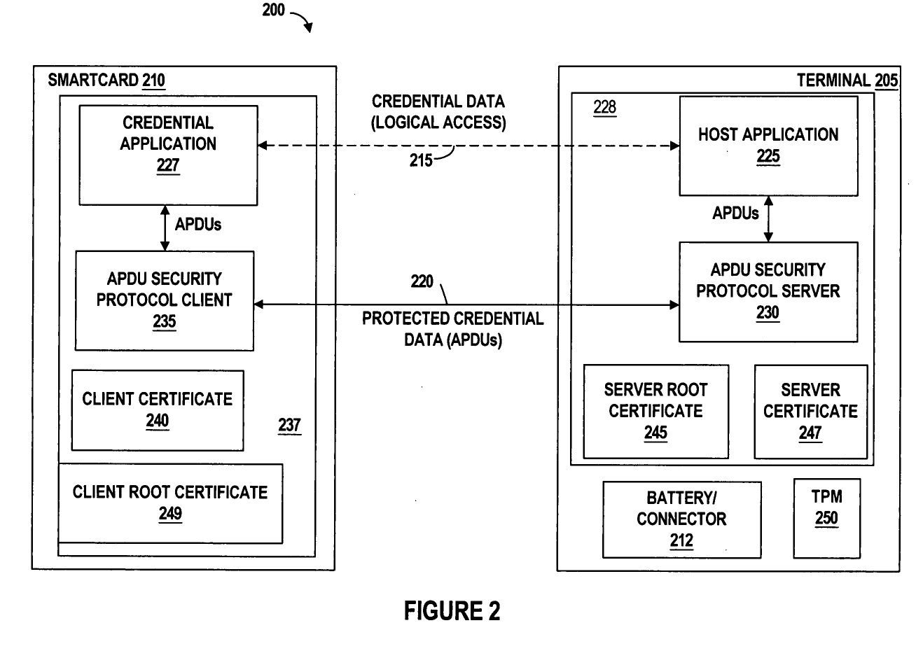

FIG. 2 is a high-level block diagram of an exemplary environment 200 that may advantageously implement the secure communications approach of one or more embodiments. The environment 200 includes a terminal 205 and a smartcard and/or smartcard reader 210 as described above. The terminal 205 of some embodiments includes trusted hardware and software (not shown) and is capable of establishing a protected partition to provide for protected execution of software applications. The trusted hardware and software of various embodiments may also include secure storage associated with one or both of the smartcard 210 and the Terminal 205. For embodiments for which the Terminal 205 is a mobile electronic system, the Terminal may include a battery or battery connector 212 to enable the Terminal to be powered by other than an AC power source.

Trusted, as the term is used herein in relation to a system, software, firmware and/or hardware, indicates that the source of the associated hardware, firmware and/or software is known and can be verified, that its state can be measured and verified at any point in time, and that it behaves in the intended way. Secure or protected, as the terms are used herein in reference to storage, for example, indicate that the associated storage or element has sufficient protections associated with it to prevent access by untrusted or unauthorized sources.

For some embodiments, as mentioned above, the smartcard 210 may be included within a module such as, for example, a General Packet Radio Service (GPRS) card module, a cellular telephone, a Personal Digital Assistant (PDA) etc. and/or may include or be coupled to the terminal via another type of smartcard reader. A smartcard 210 in accordance with various embodiments may be substantially compliant with ISO/IEC 7816 Part 4, Inter-industry Commands for Interchange and ETSI TS 102 221 version 4.3.0 specifications (UICC) and/or similar and/or future versions of such specifications and, for some embodiments, may include additional Public Key Infrastructure (PKI) support as described in more detail below. Smartcards compliant with ISO/IEC 7816 Part 4 and/or ETSI TS 102 221 version 4.3.0 support data communications using packets referred to as Application Protocol Data Units (APDUs). Further, the smartcard (ICC or UICC) of some embodiments supports T=0 protocol and mapping from C-APDUs (Command—APDU) to C-TPDUs (Command—Transfer Protocol Data Unit).

For some embodiments, the terminal 205 may support ISO 7816 Part 4 (ISO 7816-4) APDUs and UICC-Terminal Interface APDUs specified in ETSI TS 102 221 version 4.3.0 or equivalent. The APDU interface may not necessarily be a physical interface. If a smartcard is embedded inside a GPRS (General Packet Radio Service) module, or is accessible remotely over a Bluetooth™ local interface, for example, the local link transport layer protection protocol of some embodiments, described in more detail below, may still function as long as the underlying transport provides reliable message delivery.

The terminal 205 and the smartcard and/or smartcard reader 210 communicate over link(s) (or buses) 215 and 220, which may be provided by the same physical or virtual link (e.g. a single bus or wireless link). For such embodiments, the link 215 represents data communications between the terminal 205 and the smartcard 210 outside of the secure communications protocol of some embodiments, while the link 220 represents protected data communications between the terminal 205 and the smartcard 210.

Links 215 and 220 (or the single link/bus represented by the links 215 and 220) may be implemented in any one of a variety of ways. For example, the link(s) may be provided by a wireless link such as a Bluetooth™ local interface, a wireless local area network (WLAN) connection (e.g. 802.11a/b/g) or another type of wireless link operating at the same frequency band—2.4 GHz ISM (Industrial, Scientific and Medical) band—such as a microwave link, a HomeRF LAN, a link in accordance with IEEE 802.15.1 (Wireless Personal Area Network (WPAN)), another emerging IEEE standard link, a ZigBee link or a cordless telephone link, for example. Wired local connections such as, for example, a Universal Serial Bus (USB) connection may also be used for some embodiments.

For the exemplary environment 200, the terminal 205 stores or has access to a host application 225 that may communicate with a credential application 227 on the smartcard 210 when executed. For embodiments for which the smartcard 210 is or includes a Subscriber Identity Module (SIM), the host application 225 may be an EAP-SIM (Extensible Authentication Protocol-SIM) application, for example and the credential application may be a wireless local area network-SIM (WLAN-SIM) application. Other types of host and/or smartcard-based applications and associated communications between the applications are within the scope of various embodiments.

It will be appreciated that one or both of the smartcard 210 and the terminal 205 may include, be coupled to or have access to elements not shown in FIG. 2. For example, for embodiments for which the terminal 205 is a personal computing system, the terminal 205 may include a processor, a chipset, and other components and/or modules typically included in a personal computing system.

In order to provide for secure communications between the terminal 205 and the smartcard or smartcard reader 210, for one embodiment, the environment 200 implements a local link transport layer protection protocol as described in more detail below. The local link transport layer protection protocol of some embodiments may be considered to be an adaptation of the Transport Layer Security (TLS) protocol set forth in IETF RFC 2246, which is an element of the TCP/IP (Transmission Control Protocol/Internet Protocol) protocol suite. In particular, for such embodiments, the platform supporting the local link transport layer protection protocol (e.g., notebook PC) may implement the key derivation and cryptographic procedures for TLS as well as the usage models of individual cipher suites that are supported by the local link transport layer protection protocol to preserve significant TLS security properties. Further, like TLS, the local link transport layer protection protocol implements data protection in the transport layer as defined in the Open Systems Interconnect (OSI) seven layer model or a corresponding layer with a similar function in a different type of model. For such embodiments, where the trusted smartcard interface is based on APDUs, the local link transport layer protection protocol may alternately be referred to herein as APDU-TLS or the APDU-TLS protocol.

To implement the local link transport layer protection protocol, the terminal 205 stores in a data store 228 or has access via a machine-accessible medium (which may alternately be represented by the storage 228) to a local link transport layer protection protocol server application or applet 230 (APDU-TLS server application 230 for the exemplary embodiment of FIG. 2). The data store 228 may be software- or hardware-based (e.g. a Trusted Platform Module (TPM) 250 may be used to provide some or all of the data storage discussed in reference to the terminal 205). The data store may be used for storing the keys and certificates required to support APDU-TLS. It will be appreciated that, for some embodiments, one or more of the elements shown as being stored in the data store or machine-accessible medium 228 may alternatively be stored in the TPM 250 or in another data store or machine-accessible medium not shown in FIG. 2.

The server application 230 works in conjunction with a local link transport layer protection protocol client application 235 (APDU-TLS client application 235 for the exemplary embodiment of FIG. 2) stored on or accessible by the smartcard 210. The client application 235 may be stored in a data store or machine-accessible medium 237 as described above in reference to the terminal 205 and may be implemented as an applet or as a library that is part of an applet capable of performing the local link transport layer protection protocol with the Terminal 205.

To provide for protected communications between the terminal 205 and the smartcard 210, a local link transport layer protection protocol session is first established between the terminal 205 and the smartcard 210 by the server and client applications 230 and 235. This includes performing a mutual authentication process. Thereafter, credential data may be accessed from the smartcard credential application 227 by the host application 225 over the local link transport layer protocol-protected channel 220 as described in more detail below.

To support the mutual authentication process, for one embodiment, the smartcard 210 stores at least one unique client certificate 240 (e.g., issued by a Certificate Authority (CA)) that is trusted by the Terminal 205 and the Terminal 205 stores at least one root certificate 245 (e.g., of the same CA) for establishing trust. Similarly, the Terminal 205 stores at least one unique server certificate 247 issued by a CA trusted by the smartcard 210 and the smartcard stores at least one root certificate 249 from the same CA. In each case, if more than one certificate is available, the first certificate may be the default.

The local link transport layer protection or APDU-TLS protocol of various embodiments supports either credential certificates or authorization certificates so long as they provide for authentication of the smartcard-Terminal communication link. For some embodiments, the Terminal 205 and the smartcard 210 may use different certificate formats for performance reasons. For example, the server certificate may be based on the Card Verifiable format described in section 14.7 of the Application Interface for Smart Cards Used as Secure Signature Creation Devices—Part 1 Basic Requirements Version 1.07; 10 Jul. 2003. Such certificates use RSA signature algorithms and the data elements are encoded using Tag-Length-Values.

The smartcard certificate 240 may be based on a profile of the X.509v3 certificate format specified in RFC 2459 and the base 64 encoded PEM files according to coding rules specified in RFC 1421. The smartcard certificate 240 of various embodiments may support a signature algorithm (e.g., RSA) and possess an RSA public key at a minimum (possibly a 1024 bit key). The size of the associated datastructure is therefore dependent on the contents of the certificate data. The private key(s) associated with this certificate(s) may be stored in a protected area of the smartcard 210 that is not accessible by any Terminal 205 applications or applications on the smartcard 210 other than the credential application 227, such as a trusted storage partition of the data store 237, for example.

A root CA datastructure on the ICC 210 may be used to store the root certificate(s) 249, which are CA public keys for certificate signature validation. Depending on the particular format, there may be information regarding the CA in addition to the public key stored in this file. But where the RSA signature algorithm is used and a minimum of 1024 bit RSA public key is needed, the length of this file may be greater than or equal to 128 bytes for some embodiments.

Specific certificate format details and signature verification details may vary for different embodiments so long as the local link transport layer protection protocol messages for sending and receiving a certificate are used, appropriate signature verification is performed and status is indicated when errors are encountered.

Assuming a simplified PKI (Public Key Infrastructure) model, support for certificate chains up to 3 levels may be required for certain applications. The details of the PKI model, may be specific to the particular deployment. No revocation ability is assumed, however, such that the scope of the certificates may be restricted to securing the communication channel between the smartcard and/or smartcard reader 210 and the Terminal 205.

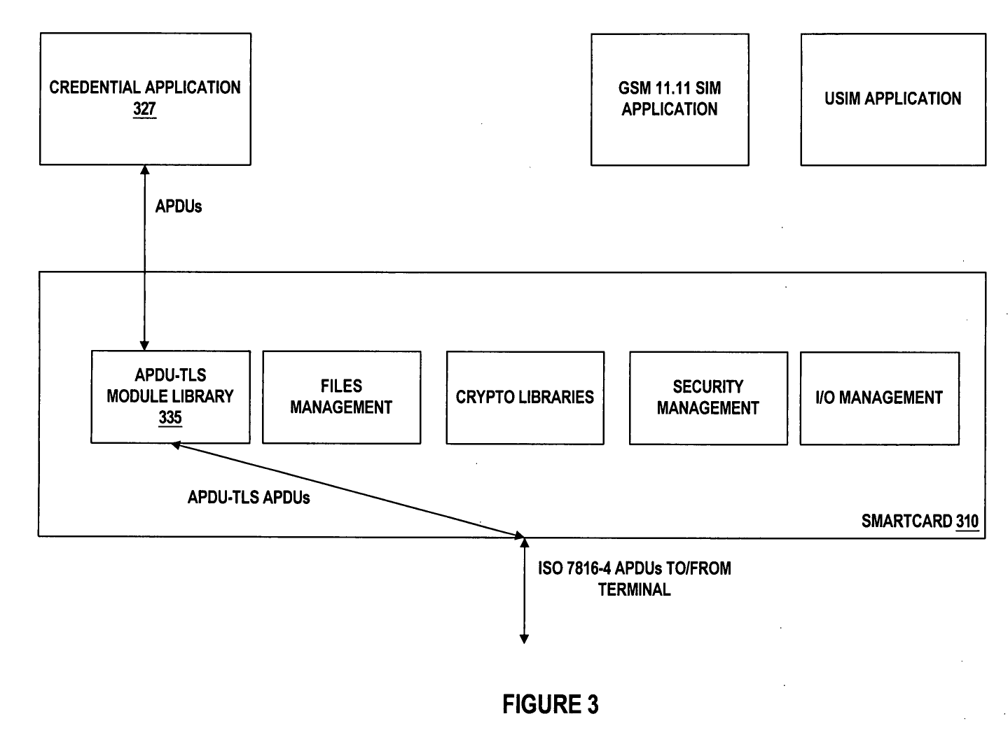

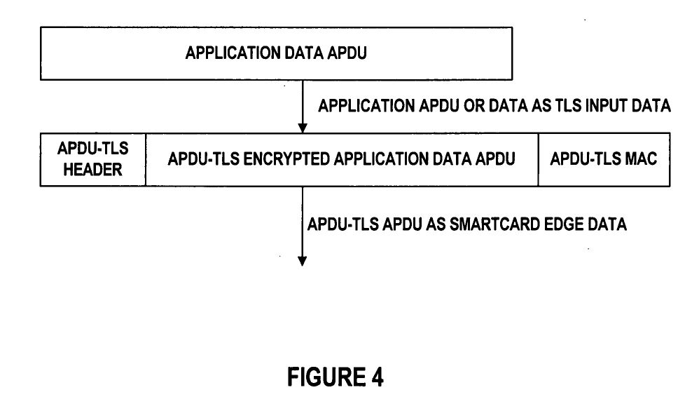

FIG. 3 is a high-level block diagram illustrating the general architecture of an ADPU-TLS-enabled smartcard 310 that may be used as the smartcard 210 of FIG. 2. As shown and described in more detail below, APDUs to/from a Terminal are handled first by an APDU-TLS module 335, which may correspond to the APDU Security protocol client application 235 of FIG. 2 in function, features and operation. The APDU-TLS module 335 may then unwrap the APDUs and deliver them to the credential application 327, which may correspond to the credential application 227 of FIG. 2. FIG. 4 is a diagram illustrating the basic protocol encapsulation model of one embodiment.

Referring back to FIG. 3, other modules on the smartcard 310 may include, for example, a file management module 360, cryptographic libraries, 365, a security management module 370 and an input/output (I/O) module 375. Smartcards and/or smartcard readers according to other embodiments may include a different set of modules than those shown in FIG. 3.

Referring back to FIG. 2, in operation, the smartcard-Terminal interface uses the APDU-TLS protocol in such a way that, for an authentication process, the terminal is effectively a server and the smartcard is effectively a client. The APDU-TLS or local link transport layer protection protocol of various embodiments may be defined as terminal 205 commands and corresponding responses from the smartcard 210. All the commands are issued by the terminal 205 and procedure bytes (APDUs) are used for status at the transport level. In most cases, the terminal 205 uses a GET RESPONSE or similar type of command to read the returned data from the smartcard 210.

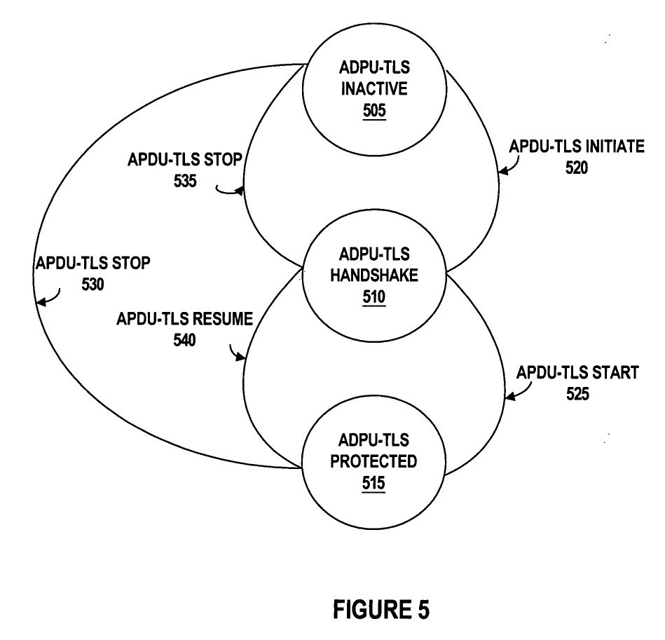

FIG. 5 is a state diagram illustrating the macro states and macro events associated with the local link transport layer protection protocol (interchangeably referred to herein as APDU-TLS) of some embodiments.

Referring to FIGS. 2 and 5, the APDU-TLS session between the smartcard 210 and the terminal 205 has three main states: APDU-TLS INACTIVE 505 (no APDU-TLS session), APDU-TLS HANDSHAKE 510 (APDU-TLS Session initiated and Handshake in progress) and APDU-TLS PROTECTED 515 (Handshake completed and Protected Session activated). These states are not individual protocol states between messages, but rather macro states that indicate the general behavior of a set of messages between the server application 230 on the terminal 205 and the smartcard 210. Associated macro events cause transitions between the macro states that result in protocol exchanges between the terminal 205 and the smartcard 210 as shown in FIG. 5.

In particular, at the APDU-TLS inactive state 505, there is no APDU-TLS session either initiated or in progress. This is a default state when no application using the APDU-TLS module library 235 (or 335 in FIG. 3) has been activated. For one implementation, when an application using APDU-TLS is activated, the Terminal 205 will use a SELECT DF_{APDU-TLS} or other type of command to read configuration information. After evaluating the configuration information that may include Cipher Suite information, Authentication options, Certificate formats, etc., if the Terminal 205 determines that an APDU-TLS session is to be initiated, it will select an application that has been enabled by APDU-TLS and it will invoke a TLS initiate event 520.

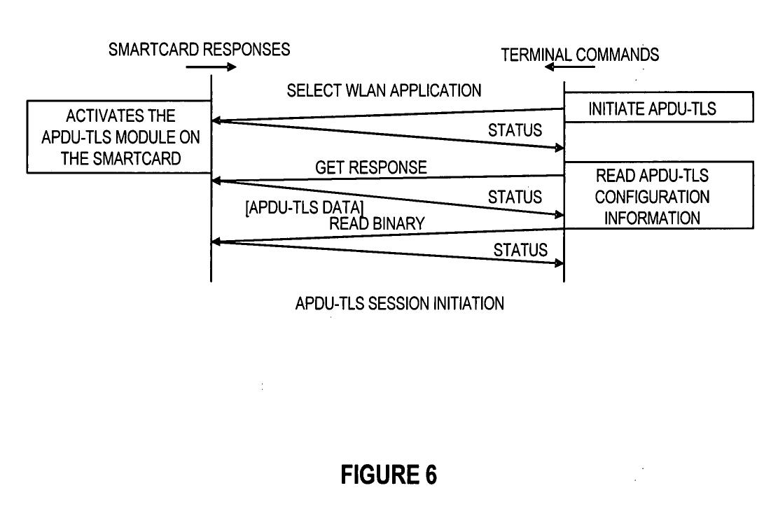

FIG. 6 is a diagram illustrating the various individual protocol actions between the smartcard 210 and the terminal 205 that may occur in response to the TLS initiate event for one embodiment, and cause a macro state transition to the APDU-TLS HANDSHAKE state.

The initiation involves the terminal server selecting the APDU-TLS application and starting the session handshake. For one exemplary embodiment in which the smartcard may include a SIM to be used to enable WLAN communications, as shown in FIG. 6, the terminal 205 may issue a SELECT WLAN Application or similar type of command to the smartcard 210. The smartcard 210 responds with a STATUS giving the result of the command. If the command is successful, a GET RESPONSE or similar type of command may be used to read the ADPU-TLS Data from the smartcard 210. A READ BINARY or similar command may be used to read configuration data from the smartcard 210. After this operation, the smartcard 210 is in the APDU-TLS HANDSHAKE macro state.

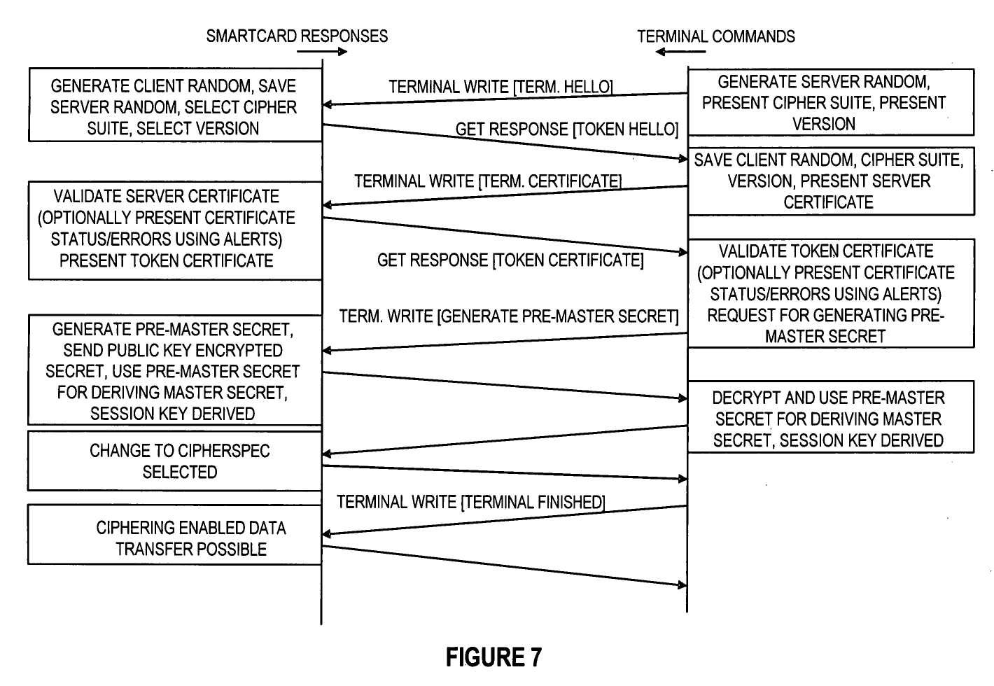

Referring back to FIGS. 2 and 5, the APDU-TLS HANDSHAKE state 510 implies that an APDU-TLS session is being established. This state has no ciphering active in the APDU-TLS record protocol. The APDU-TLS handshake process is performed in this state by the terminal 205 and the smartcard 210. This involves several protocol actions as shown in FIG. 7. In FIG. 7, the command/response notation is simplified to show only the logical messages. For example, while GET RESPONSE is a command, it is shown as a response because it effectively allows reading a response.

As shown in FIG. 7, the handshake process involves various actions and exchanges including generating server and client random numbers, presenting and validating certificates, indicating any errors, requesting and generating a pre-master secret, deriving a master secret and a session key, selecting a change to the cipher spec and enabling ciphering.

For random number generation, the smartcard 210 should have a good source of randomness for generating the client random number. For one embodiment the Trusted Platform Module (TPM) 250 (FIG. 2) may be used to generate the client random number. Further, for performance reasons, it may be desirable for some embodiments to implement cryptographic operations in hardware to avoid large latencies although cryptographic operations may be implemented in software for other embodiments. The key cryptographic blocks are AES, MD5, SHA and RSA public key/private key operations. For RSA, a 1024 bit public key size may be used for some embodiments. For AES, support for 256 bits may be desirable, but a smaller or larger number of bits may be supported for various embodiments.

Thus, after mutual authentication of the terminal 205 and the token or smartcard 210, keying material is derived so that the rest of the traffic between the token 210 and the end point on the terminal or platform 205 is encrypted. To further secure the key generation and storage of keys, for some embodiments, referring to FIG. 2, the Trusted Platform Module (TPM) 250, which is a cryptographic co-processor, or other fixed token may be used. The TPM 250 may also be used to achieve platform binding if desired.

Again, referring back to FIGS. 2 and 5, in response to successful completion of the handshake process/session, the APDU-TLS START macro event 525 causes a transition to the APDU-TLS PROTECTED macro state 515 in which an APDU-TLS session is made active and protected data transfer can occur.

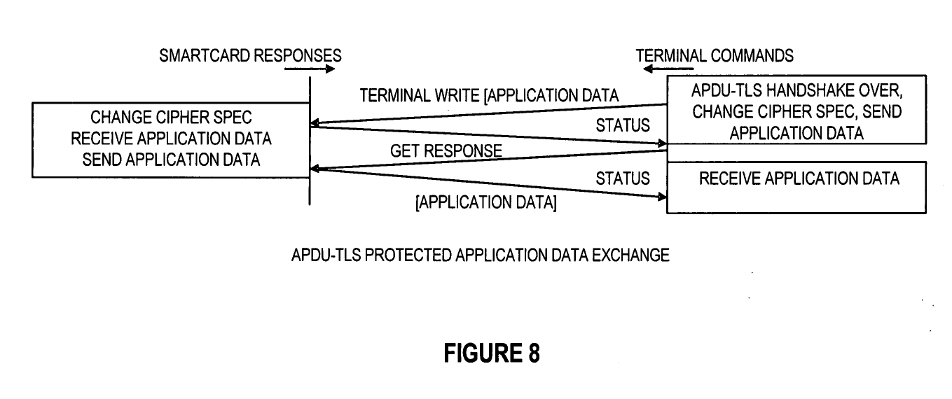

FIG. 8 illustrates the protected application data exchange in the APDU-TLS PROTECTED state. In this state, referring also to FIGS. 2 and 3, a TERMINAL WRITE or similar type of command may be used to write applications APDUs that need to be sent to the smartcard 210. A GET RESPONSE or GET BINARY command may be used to read the application APDUs from the smartcard 210. The APDU-TLS module 235 (or 335) protects the data using the cipher spec that was negotiated in the APDU-TLS HANDSHAKE macro state.

While in the APDU-TLS PROTECTED STATE or the APDU-TLS HANDSHAKE state, an APDU-TLS STOP EVENT 530 or 535 may occur indicating that the terminal 205 desires to terminate the APDU-TLS session. If this event occurs in the APDU-TLS INACTIVE state, it may be ignored for some embodiments. For one embodiment, a specific APDU may be sent to terminate the APDU-TLS session (e.g. ALERT(close_notify) for one specific embodiment).

For some embodiments, an APDU-TLS RESUME or similar event 540 may also be used to re-negotiate a session with fresh session keys and may be invoked on a periodic basis set by Terminal 205 policy.

While the local link transport layer protection protocol described herein may be considered to be an adaptation of the TLS protocol for some embodiments, it may not be compatible with the TLS protocol and there may be some notable differences. For example, the local link transport layer protection protocol may support only a subset of the TLS cipher suites described in IETF RFC 3268 for computation of cryptographic values and may use a modified protocol message set. Further in contrast to the TLS protocol, for the local link transport layer protection protocol, the client may select the cipher suite instead of the server. Additionally, mutual authentication may be mandated for some embodiments.

Thus, various embodiments of an approach for securing communications between a credential and a platform are described. In the foregoing specification, the invention has been described with reference to specific exemplary embodiments thereof. It will, however, be appreciated that various modifications and changes may be made thereto without departing from the broader spirit and scope of the invention as set forth in the appended claims. For example, while specific exemplary commands have been described herein, it will be appreciated that different commands that cause similar operations to be performed may be used for other embodiments. The specification and drawings are, accordingly, to be regarded in an illustrative rather than a restrictive sense.

What is claimed is:

1. A method comprising:
receiving a command to initiate a local link transport layer protection protocol session between a terminal and one of a smartcard and a smartcard reader;
participating in a handshake process between the terminal and one of the smartcard and the smartcard reader, the handshake process including mutual authentication; and
providing data from one of the smartcard and the smartcard reader to the terminal via a trusted tunnel after successful completion of the handshake process.

2. The method of claim 1 wherein
receiving the command to initiate the local link transport layer protection protocol session between the terminal and one of the smartcard and the smartcard reader includes receiving the command to initiate the local link transport layer protection protocol session between a personal computer and one of the smartcard and the smartcard reader.

3. The method of claim 2 wherein
receiving the command to initiate the local link transport layer protection protocol session between the terminal and one of the smartcard and the smartcard reader includes receiving the command to initiate the local link transport layer protection protocol session between a personal computer and one of a Subscriber Identity Module (SIM), a Universal SIM (USIM) card, a Removable User Identity Module (RUIM), an IP Multimedia Services Identity Module (ISIM), a Wireless Identity module (WIM), a Java Card and a reader.

4. The method of claim 1 wherein
providing data from one of the smartcard and the smartcard reader to the terminal via a trusted tunnel after successful completion of the handshake process includes providing data over a wireless link via a trusted tunnel.

5. The method of claim 4 wherein
providing data over the wireless link includes providing data over one of a Bluetooth link a wireless local area network (WLAN) connection and a wireless link operating in the 2.4 GHz ISM (Industrial, Scientific and Medical) band.

6. The method of claim 1 wherein
providing data from one of the smartcard and the smartcard reader to the terminal via a trusted tunnel after successful completion of the handshake process includes providing data over a wired link.

7. The method of claim 6 wherein providing data over the wired link includes providing data over a Universal Serial Bus link.

8. The method of claim 1 wherein
participating in the handshake process includes using TLS (Transport Layer Security) key derivation procedures.

9. A method comprising:
issuing a command to initiate a local link transport layer protection protocol session between a terminal and one of a smartcard and a smartcard reader;
participating in a handshake process between the terminal and one of the smartcard and the smartcard reader, the handshake process including mutual authentication; and
receiving data from one of the smartcard and the smartcard reader via a trusted tunnel after successful completion of the handshake process.

10. The method of claim 9 wherein
issuing a command to initiate a local link transport layer protection protocol in response to a host application accessible by the terminal invoking a client application to be executed by the smartcard 210.

11. The method of claim 10 wherein the host application is an Extensible Authentication Protocol Subscriber Identity Module (EAP-SIM) application and the client application is a Wireless Local Area Network-SIM (WLAN-SIM) application.

12. The method of claim 9 wherein
issuing the command to initiate the local link transport layer protection protocol session between the terminal and one of the smartcard and the smartcard reader includes issuing the command to initiate the local link transport layer protection protocol session between a personal computer and one of the smartcard and the smartcard reader.

13. The method of claim 12 wherein
issuing the command to initiate the local link transport layer protection protocol session between the terminal and one of the smartcard and the smartcard reader includes issuing the command to initiate the local link transport layer protection protocol session between a personal computer and one of a Subscriber Identity Module (SIM), a Universal SIM (USIM) card, a Removable User Identity Module (RUIM), an IP Multimedia Services Identity Module (ISIM), a Wireless Identity module (WIM), a Java Card and a reader.

14. The method of claim 9 wherein
receiving data from one of the smartcard and the smartcard reader to the terminal via a trusted tunnel after successful completion of the handshake process includes receiving data over a wireless link via a trusted tunnel.

15. The method of claim 14 wherein
receiving data over the wireless link includes receiving data over one of a Bluetooth link a wireless local area network (WLAN) connection and a wireless link operating in the 2.4 GHz ISM (Industrial, Scientific and Medical) band.

16. The method of claim 9 wherein
receiving data from one of the smartcard and the smartcard reader to the terminal via a trusted tunnel after successful completion of the handshake process includes receiving data over a wired link.

17. The method of claim 16 wherein receiving data over the wired link includes receiving data over a Universal Serial Bus link.

18. The method of claim 9 wherein
receiving data via the trusted tunnel includes receiving data using TLS (Transport Layer Security) cryptographic procedures.

19. An apparatus comprising:
one of a smartcard and a smartcard reader; and
a data store storing a local link transport layer protection protocol client, the local link transport layer protection protocol client to implement in conjunction with a local link transport layer protection protocol server a local link transport layer protection protocol to establish a trusted tunnel between one of the smartcard and the smartcard reader and a terminal.

20. The apparatus of claim 19 wherein
one of the smartcard and the smartcard reader includes one of a Subscriber Identity Module (SIM), a Universal SIM (USIM) card, a Removable User Identity Module (RUIM), an IP Multimedia Services Identity Module (ISIM), a Wireless Identity module (WIM), a Java Card and a reader.

21. The apparatus of claim 20 wherein
the terminal includes one of personal computing system and a personal digital assistant.

22. The apparatus of claim 19 wherein
the reader includes one of a mobile telephone and a personal digital assistant.

23. The apparatus of claim 19 wherein
one of the smartcard and the smartcard reader is to be coupled to the terminal over a local link connection, the trusted tunnel to be provided over the local link connection, the local link connection being one of a Bluetooth, a Wireless Local Area Network (WLAN), a connection operating in the 2.4 GHz ISM (Industrial, Scientific and Medical) band and a Universal Serial Bus (USB) connection.

24. A system comprising:
a data store storing a local link transport layer protection protocol server, the local link transport layer protection protocol server to implement in conjunction with a local link transport layer protection protocol client, a local link transport protection protocol to establish a trusted tunnel between the system and one of a smartcard and a smartcard reader; and
a battery connection to receive a battery to provide power to the system.

25. The system of claim 24 wherein the system is one of a personal computing system and a personal digital assistant.

26. The system of claim 24 wherein
one of the smartcard and the smartcard reader is to be coupled to the system over a local link connection, the trusted tunnel to be provided over the local link connection, the local link connection being one of a Bluetooth, a Wireless Local Area Network (WLAN), a connection operating in the 2.4 GHz ISM (Industrial, Scientific and Medical) band and a Universal Serial Bus (USB) connection.

27. The system of claim 26 further comprising
a Trusted Platform Module (TPM), the Trusted Platform Module to provide protected storage for data associated with the local link transport layer protection protocol.

28. The system of claim 24 wherein
the data store further stores a host application, the host application to invoke a client application to be executed by the smartcard, a local link transport layer protection protocol session to be invoked in response to invocation of the client application.

29. The system of claim 28 wherein
the host application is an Extensible Authentication Protocol Subscriber Identity Module (EAP-SIM) application and the client application is a Wireless Local Area Network-SIM (WLAN-SIM) application.

30. A machine-accessible medium storing data that, when accessed by a machine, causes the machine to:
initiate a local link transport layer protection protocol session between a terminal and one of a smartcard and a smartcard reader;
participate in a handshake process between the terminal and one of the smartcard and the smartcard reader, the handshake process including mutual authentication; and
receive data from one of the smartcard and the smartcard reader via a trusted tunnel after successful completion of the handshake process.

31. The machine-accessible medium of claim 30 wherein
initiating a local link transport layer protection protocol is in response to a host application accessible by the terminal invoking a client application to be executed by the smartcard 210.

32. The machine-accessible medium of claim 30 wherein
initiating the local link transport layer protection protocol session between the terminal and one of the smartcard and the smartcard reader includes issuing a command to initiate the local link transport layer protection protocol session between a personal computer and one of the smartcard and the smartcard reader.

33. The machine-accessible medium of claim 32 wherein
issuing the command to initiate the local link transport layer protection protocol session between the terminal and one of the smartcard and the smartcard reader includes issuing the command to initiate the local link transport layer protection protocol session between a personal computer and one of a Subscriber Identity Module (SIM), a Universal SIM (USIM) card, a Removable User Identity Module (RUIM), an IP Multimedia Services Identity Module (ISIM), a Wireless Identity module (WIM), a Java Card and a reader.

34. The machine-accessible medium of claim 30 wherein
receiving data from one of the smartcard and the smartcard reader to the terminal via a trusted tunnel after successful completion of the handshake process includes receiving data over a wireless link via a trusted tunnel.

35. The machine-accessible medium of claim 34 wherein
receiving data over the wireless link includes receiving data over one of a Bluetooth link a wireless local area network (WLAN) connection and a wireless link operating in the 2.4 GHz ISM (Industrial, Scientific and Medical) band.

36. The machine-accessible medium of claim 30 wherein
receiving data from one of the smartcard and the smartcard reader to the terminal via a trusted tunnel after successful completion of the handshake process includes receiving data over a wired link.

37. The machine-accessible medium of claim 30 wherein
receiving data via the trusted tunnel includes receiving data using TLS (Transport Layer Security) cryptographic procedures.

38. A machine-accessible medium storing data that, when accessed by a machine, causes the machine to:
receive a command to initiate a local link transport layer protection protocol session between a terminal and one of a smartcard and a smartcard reader;
participate in a handshake process between the terminal and one of the smartcard and the smartcard reader, the handshake process including mutual authentication; and
provide data from one of the smartcard and the smartcard reader to the terminal via a trusted tunnel after successful completion of the handshake process.

39. The machine-accessible medium of claim 38 wherein
receiving the command to initiate the local link transport layer protection protocol session between the terminal and one of the smartcard and the smartcard reader includes receiving the command to initiate the local link transport layer protection protocol session between a personal computer and one of the smartcard and the smartcard reader.

40. The machine-accessible medium of claim 39 wherein
receiving the command to initiate the local link transport layer protection protocol session between the terminal and one of the smartcard and the smartcard reader includes receiving the command to initiate the local link transport layer protection protocol session between a personal computer and one of a Subscriber Identity Module (SIM), a Universal SIM (USIM) card, a Removable User Identity Module (RUIM), an IP Multimedia Services Identity Module (ISIM), a Wireless Identity module (WIM), a Java Card and a reader.

41. The machine-accessible medium of claim 38 wherein
providing data from one of the smartcard and the smartcard reader to the terminal via a trusted tunnel after successful completion of the handshake process includes providing data over a wireless link via a trusted tunnel.

42. The machine-accessible medium of claim 38 wherein
providing data from one of the smartcard and the smartcard reader to the terminal via a trusted tunnel after successful completion of the handshake process includes providing data over a wired link.

43. The machine-accessible medium of claim 38 wherein
participating in the handshake process includes using TLS (Transport Layer Security) key derivation procedures.
